(19) United States
(12) Patent Application Publication
(10) Pub. No.: US 2025/0214351 A1
(43) Pub. Date: Jul. 3, 2025

(54) HIGH-SPEED MONITORING SYSTEM FOR INKJET INK DROPLETS WITH 1D AND 2D IMAGE ACQUISITION DEVICES AND HIGH-SPEED MONITORING METHOD USING THE SAME

(71) Applicant: PUKYONG NATIONAL UNIVERSITY INDUSTRY-UNIVERSITY COOPERATION FOUNDATION, Busan (KR)

(72) Inventor: Dong Youn SHIN, Busan (KR)

(73) Assignee: PUKYONG NATIONAL UNIVERSITY INDUSTRY-UNIVERSITY COOPERATION FOUNDATION, Busan (KR)

(21) Appl. No.: 19/082,615

(22) Filed: Mar. 18, 2025

Related U.S. Application Data
(63) Continuation of application No. PCT/KR2023/016579, filed on Oct. 24, 2023.

(30) Foreign Application Priority Data
May 3, 2023 (KR) 10-2023-0057882

(51) Int. Cl. B41J 3/44; B41J 3/46; G06T 7/00; G06T 7/62

(52) U.S. Cl. CPC B41J 3/445; B41J 3/46; G06T 7/0004; G06T 7/62; G06T 2207/30144

(57) ABSTRACT

Provided are a high-speed monitoring system for inkjet ink droplets with 1D and 2D image acquisition devices and a high-speed monitoring method using the same, which selectively acquires image data by using a reflecting mirror to switch between an operation of acquiring high-resolution, low-volume image data of ink droplets falling from an inkjet print head using a wide 1D line scan camera and an operation of acquiring shape image data of ink droplets which has a narrower FOV (Field of View) than the wide 1D line scan camera using a 2D area scan camera, and processes the images to acquire precise relative comparison data of ink droplets falling from a large number of nozzles from the wide 1D line scan camera and to acquire basic physical characteristic data of ink droplets falling from a smaller number of nozzles than the nozzles from the 2D area scan camera.

### CROSS-REFERENCE TO RELATED APPLICATIONS

This application is a continuation of International Application No. PCT/KR2023/016579 filed on Oct. 24, 2023, which claims priority to Korean Patent Application No. 10-2023-0057882 filed on May 3, 2023, the entire contents of which are herein incorporated by reference.

### TECHNICAL FIELD

The present invention relates to a high-speed monitoring system for inkjet ink droplets with 1D and 2D image acquisition devices and a high-speed monitoring method using the same. Specifically, the invention relates to a high-speed monitoring system for inkjet ink droplets with 1D and 2D image acquisition devices and a high-speed monitoring method using the same, which selectively acquires image data by using a reflecting mirror to switch between an operation of acquiring high-resolution, low-volume image data of ink droplets falling from an inkjet print head using a wide 1D line scan camera and an operation of acquiring shape image data of ink droplets which has a narrower FOV (Field of View) than the wide 1D line scan camera using a 2D area scan camera, and processes the images to acquire precise relative comparison data of ink droplets falling from a large number of nozzles from the wide 1D line scan camera and to acquire basic physical characteristic data of ink droplets falling from a smaller number of nozzles than the nozzles from the 2D area scan camera.

### BACKGROUND ART

A conventional method for constructing subpixels of a display panel involves manufacturing the color filter of the display panel by repeatedly applying one of the three color resists—red, green, or blue—over the entire surface of the display panel and then using a photolithography process to leave the desired color resist only on the desired subpixels.

However, manufacturing using this method results in significant material waste and presents challenges when dealing with expensive materials, such as OLED (Organic Light-Emitting Diode) and QD (Quantum Dot), which are sensitive to post-processing steps involving chemical agents and high temperatures. Consequently, patterning technologies, such as inkjet printing, which can deposit a precise amount of ink only on the desired areas, have gained considerable attention in the display industry.

During the manufacturing of display panels, it has been necessary to quickly inspect for ejection defects or abnormalities in the ink droplets discharged from the printer head of an inkjet system. Conventionally, monitoring methods using 2D area scan cameras or laser phase Doppler measurement techniques have been employed to monitor the shape, volume and velocity of ink droplets and ejection angle from the nozzles of ink droplets

However, the ink droplet monitoring method using a 2D area scan camera has the problem that due to its narrow Field of View (FOV), only ink droplets ejected from a few nozzles can be observed in a single image frame. As a result, to inspect the ink droplets ejected from hundreds or thousands of nozzles in an inkjet print head, multiple measurements, often more than several dozen, are required, leading to a significant amount of time needed to complete the inspection.

Additionally, the laser phase Doppler measurement method cannot measure the shape of ink droplets. In particular, if the ink droplets contain particles that can scatter the laser, the scattered noise makes it impossible to measure the volume, velocity, or ejection angle of the ink droplets, which is a significant drawback of this method.

Additionally, the ink droplet monitoring method using a wide 1D line scan camera allows for high-resolution, high-speed monitoring; however, it has the limitation that it cannot measure the physical characteristics of the ink droplets (such as length, width, volume, velocity, etc.).

### DOCUMENT OF RELATED ART

### Patent Document

(Patent Document 0001) Korean Patent Publication No. 10-2017-0060383 (Title of Invention: Device and method for inspecting discharged droplets from a nozzle)

### DISCLOSURE

### Technical Problem

Accordingly, the present invention aims to provide a high-speed monitoring system for inkjet ink droplets with 1D and 2D image acquisition devices and a high-speed monitoring method using the same, capable of monitoring ink droplets falling from multiple nozzles at high speed, and acquiring the shape of ink droplets falling from a small number of nozzles and measuring their basic physical properties.

### Technical Solution

To achieve the above objective, the high-speed monitoring system for inkjet ink droplets with 1D and 2D image acquisition devices according to one aspect of the present invention comprises a light strobe using one or more LEDs or LEPs (laser-excited phosphors), configured to irradiate light for ink droplets falling from an inkjet print head; a wide 1D line scan camera positioned opposite the light strobe, configured to capture ink droplets at a set period and acquire high-resolution, low-capacity ink droplet image data; a 2D area scan camera arranged at a certain angle relative to the wide 1D line scan camera, configured to acquire ink droplet shape image data at a specific time; an optical switching unit positioned between the wide 1D line scan camera and the 2D area scan camera, configured to optically switch between use of the two cameras; and a control unit configured to collect high-resolution, low-capacity ink droplet image data captured by the wide 1D line scan camera at the set period, perform image processing to generate and image 2D spatiotemporal information of the ink droplets, acquire relative comparison data of the ink droplets using the imaged 2D spatiotemporal information, collect ink droplet shape image data captured at the specific time by the 2D area scan camera, perform image processing the ink droplet shape image data to generate 2D spatial information of the ink droplets at the specific time, image the 2D spatial information, and acquire basic physical characteristic data of the ink droplets using the imaged 2D spatial information.

The high-speed monitoring system for inkjet ink droplets with 1D and 2D image acquisition devices according to the above one aspect may further comprise a display unit configured to receive and display the relative comparison data and basic physical characteristic data of the ink droplets acquired by the control unit.

In the high-speed monitoring system for inkjet ink droplets with 1D and 2D image acquisition devices according to the above one aspect, the basic physical characteristic data of the ink droplets may include a falling velocity, length, width, and volume of the ink droplets.

In the high-speed monitoring system for inkjet ink droplets with 1D and 2D image acquisition devices according to the above one aspect, the optical switching unit may be a reflective mirror or a semi-transparent mirror.

In the high-speed monitoring system for inkjet ink droplets with 1D and 2D image acquisition devices according to the above one aspect, the optical switching unit may be configured to switch between use of the wide 1D line scan camera and the 2D area scan camera while moving linearly by a sliding device, and at this time, the sliding device may be controlled by the control unit.

In the high-speed monitoring system for inkjet ink droplets with 1D and 2D image acquisition devices according to the above one aspect, the optical switching unit may be configured to switch between use of the wide 1D line scan camera and the 2D area scan camera while adjusting its inclination angle by a folding device, and at this time, the folding device may be controlled by the control unit.

In the high-speed monitoring system for inkjet ink droplets with 1D and 2D image acquisition devices according to the above one aspect, the wide 1D line scan camera and the 2D area scan camera may be arranged either on a same axis or at a predetermined opposing angle, the optical switching unit may be configured to switch between use of the wide 1D line scan camera and the 2D area scan camera while rotating by a rotation device, and at this time, the rotation device may be controlled by the control unit.

In the high-speed monitoring system for inkjet ink droplets with 1D and 2D image acquisition devices according to the above one aspect, when the optical switching unit may be a semi-transparent mirror, the wide 1D line scan camera and the 2D area scan camera can perform simultaneous observation, and at this time, the light strobe may be configured to generate high-brightness light to compensate for the decrease in the amount of light incident on the 1D line scan camera and the 2D area scan camera by the semi-transparent mirror.

To achieve the above objective, the high-speed monitoring method according to another aspect of the present invention comprise: a step in which a control unit collects high-resolution, low-capacity ink droplet image data acquired by capturing ink droplets falling from an inkjet print head at a set period by a wide 1D line scan camera; a step in which the control unit performs image processing on the collected high-resolution, low-capacity ink droplet image data to generate and image 2D spatiotemporal information of the ink droplets; a step in which the control unit acquires relative comparison data of the ink droplets using the imaged 2D spatiotemporal information of the ink droplets; a step in which the control unit collects shape image data of ink droplets acquired by capturing the ink droplets falling from the inkjet print head at a specific time by a 2D area scan camera; a step in which the control unit performs image processing the collected shape image data of the ink droplets to generate and image 2D spatiotemporal information of the ink droplets at the specific time; a step in which the control unit acquires basic physical characteristic data of the ink droplets using 2D spatial information of the imaged ink droplets; and a step in which a display unit receives and displays the relative comparison data and basic physical characteristic data of the ink droplets obtained by the control unit.

### Advantageous Effects

According to the high-speed monitoring system for inkjet ink droplets with 1D and 2D image acquisition devices according to an aspect of the present invention and the high-speed monitoring method using the same, the use of two cameras is optically switched by the optical switching unit disposed between the wide 1D line scan camera and the 2D area scan camera, the high-resolution, low-capacity ink droplet image data captured at the set period by the wide 1D line scan camera is collected and image-processed to generate and image 2D spatiotemporal information of the ink droplets, the relative comparison data of the ink droplets is acquired using the imaged 2D spatiotemporal information, the shape image data of the ink droplets captured at the specific time by the 2D area scan camera is collected and image-processed to generate and image 2D spatiotemporal information of the ink droplets at the specific time, and the basic physical characteristic data of the ink droplets is acquired using the 2D spatiotemporal information of the imaged ink droplets, thereby capable of monitoring ink droplets falling from multiple nozzles at high speed, and acquiring the shape of ink droplets falling from a small number of nozzles and measuring their basic physical properties.

### DESCRIPTION OF DRAWINGS

FIG. 1 is a block diagram of the high-speed monitoring system of inkjet ink droplets with 1D and 2D image acquisition devices according to an embodiment of the present invention.

FIG. 2 is a schematic perspective view of the high-speed monitoring system of inkjet ink droplets according to the embodiment of the present invention.

FIG. 3 is a side view showing the inkjet print head and optical strobe in FIG. 2.

FIG. 4 is a diagram illustrating the state and area where the wide 1D line scan camera can observe ink droplets, when the optical switching unit is configured with a reflective mirror and performs sliding movement in the high-speed monitoring system of inkjet ink droplets of FIG. 2.

FIG. 5 is a diagram illustrating the state and area where the 2D area scan camera can observe ink droplets, when the optical switching unit is configured with a reflective mirror and performs sliding movement in the high-speed monitoring system of inkjet ink droplets of FIG. 2.

FIG. 6 is a diagram illustrating the state and area where both the wide 1D line scan camera and 2D area scan camera can simultaneously observe ink droplets, when the optical switching unit is configured with a translucent mirror in the high-speed monitoring system of inkjet ink droplets of FIG. 2.

FIG. 7 is a diagram explaining the process of collecting and performing image processing high-resolution, low-capacity ink droplet image data acquired by the wide 1D line scan camera to generate the 2D spatiotemporal information of the ink droplet in FIG. 1.

FIG. 8 is a diagram showing the difference between the 2D spatiotemporal information at continuous time t generated from the high-resolution, low-volume ink droplet image data obtained by the wide 1D line scan camera, and the 2D spatial information of ink droplets generated at a specific time t from the shape image data of ink droplets acquired by the 2D area scan camera in FIG. 1.

FIG. 9 is a flowchart for explaining the high-speed monitoring method using the high-speed monitoring system of inkjet ink droplets according to an embodiment of the present invention.

FIG. 10 is an example of the 2D spatiotemporal image of ink droplets captured by the wide 1D line scan camera.

FIG. 11 is an example of an image showing the 2D spatial information of ink droplets at a specific time, captured by the 2D area scan camera.

FIG. 12 is an example of switching between the 1D line scan camera and 2D area scan camera by folding or unfolding the optical switching unit in a folding manner.

FIG. 13 is an example of switching between the 1D line scan camera and 2D area scan camera by rotating the optical switching unit in a rotating manner.

### DETAILED DESCRIPTION OF THE INVENTION

In describing embodiments of the present disclosure, if it is decided that a detailed description of the known art related to the present disclosure makes the subject matter of the present disclosure unclear, the detailed description will be omitted. Further, the terms described below are defined in consideration of the functions in the present disclosure, and may be changed depending on the intention of a user, an operator, or a usual practice. Therefore, the definition should be based on the contents throughout this specification. The terms used below are merely for describing the embodiments of the present disclosure, and should not be restrictively interpreted. Unless clearly used otherwise, a singular expression includes a plural meaning. In the description, the expression “include” or “have” is for indicating any features, numbers, steps, operations, elements, or a part or combination thereof, and should not be interpreted as excluding presence or possibility of one or more other features, numbers, steps, operations, elements, or a part or combination thereof other than the above.

In each system shown in the drawings, elements in some cases may have same or different reference numerals to suggest that the elements could be different or similar. However, elements may have different implementations and work with some or all of the systems shown or described in the specification. The various elements shown in the drawings may be the same or different. It is random which one is referred to as a first element and which one is referred to as a second element.

In the specification, when one element “transmits”, “transfers”, or “provides” data or a signal to another element, it means that the element transmits the data or signal directly to the other element or the element transmits the data or signal to the other element via at least one another element.

Hereinafter, embodiments of the present disclosure will be described in detail with reference to the accompanying drawings.

### First Embodiment

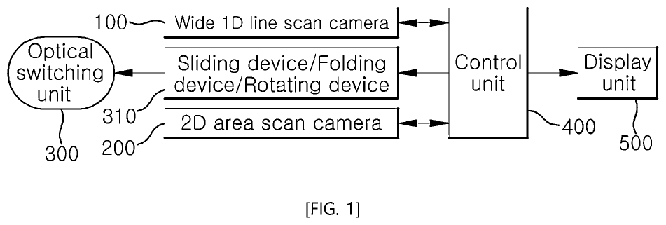

FIG. 1 is a block diagram of the high-speed monitoring system of inkjet ink droplets with a 1D and 2D image acquisition device according to an embodiment of the present invention,

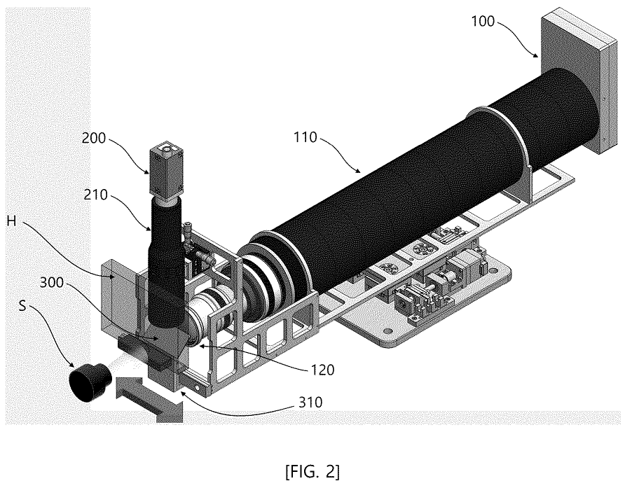

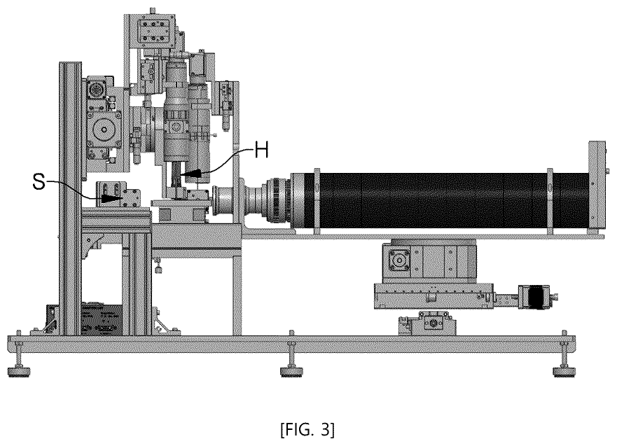

FIG. 2 is a schematic perspective view of the high-speed monitoring system of inkjet ink droplets according to an embodiment of the present invention, and FIG. 3 is a side view showing the inkjet print head and optical strobe in FIG. 2.

The high-speed monitoring system of inkjet ink droplets with a 1D and 2D image acquisition device according to an embodiment of the present invention, as shown in FIGS. 1 to 3, includes a light strobe(S), a wide 1D line scan camera (100), a 2D area scan camera (200), an optical switching unit (300), a control unit (400), and a display unit (500).

The light strobe(S) serves to illuminate light ink droplets falling from an inkjet print head (H). For example, as shown in FIGS. 2 and 3, the light strobe(S) is positioned in front of the inkjet print head (H) to illuminate light the ink droplets, allowing the wide 1D line scan camera (100) facing the light strobe(S) and the 2D area scan camera (200), which is arranged at a certain angle (e.g., 90 degrees) to the wide 1D line scan camera (100), to capture 1D images (wide 1D line scan camera) and 2D images (2D area scan camera) of ink droplets falling from the inkjet print head (H).

The light strobe(S) can be configured as a cluster or bar-type structure consisting of one or more high-brightness LEDs, or as a high-brightness sub-microsecond pulse light strobe capable of driving with short pulse of 1 microseconds or less (more preferably capable of driving with ultra short pulse of 0.5 microsecond or less) using a laser excited phosphor (LEP) method that obtains coherent light by irradiating a short-wavelength laser onto a phosphor plate.

The wide 1D line scan camera (100) is arranged facing the light strobe(S) through a lens (120) and a tube (110) and functions to capture ink droplets at a set period, thereby acquiring high-resolution, low-capacity 1D ink droplet image data.

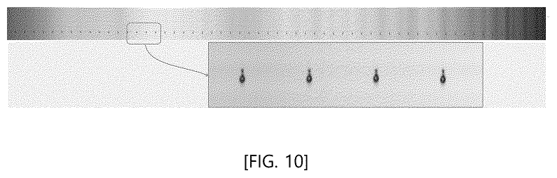

The wide 1D line scan camera (100) is capable of simultaneously and rapidly measuring ink droplets ejected from a significantly larger number of nozzles compared to the 2D area scan camera (200). Unlike the 2D area scan camera (200), it tracks how spatial information changes over continuous time and utilizes information that image it to enable precise relative comparisons of ink droplets ejected from the nozzles (see FIG. 10).

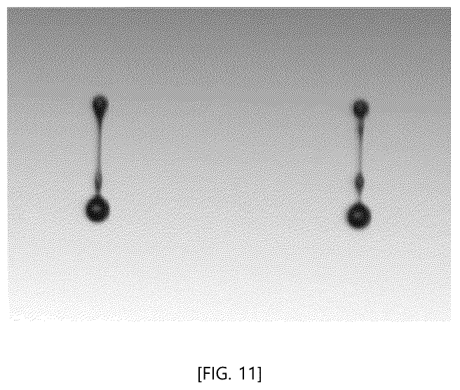

The 2D area scan camera (200) is positioned at a specific angle relative to the wide 1D line scan camera (100) and functions to acquire shape image data of ink droplets at a specific time. In FIG. 2, the 2D area scan camera (200) is arranged at 90 degrees relative to the wide 1D line scan camera (100), but it can be positioned at any angle between 0 and 180 degrees. The 2D area scan camera (200) can captures ink droplets by receiving light through a lens for 2D area scan camera (210) (see FIG. 11).

The shape image data of ink droplets at a specific time, acquired by the 2D area scan camera (200), represents 2D spatial information. This information allows the measurement of fundamental physical properties of ink droplets (the falling speed, length, width, and volume of the ink droplets.

The optical switching unit (300) is positioned between the wide 1D line scan camera (100) and the 2D area scan camera (200), and functions to switch between use of the two cameras. The optical switching unit (300) can be a reflective mirror or a translucent mirror, and it can be driven in one of the following three methods.

### [Sliding Method]

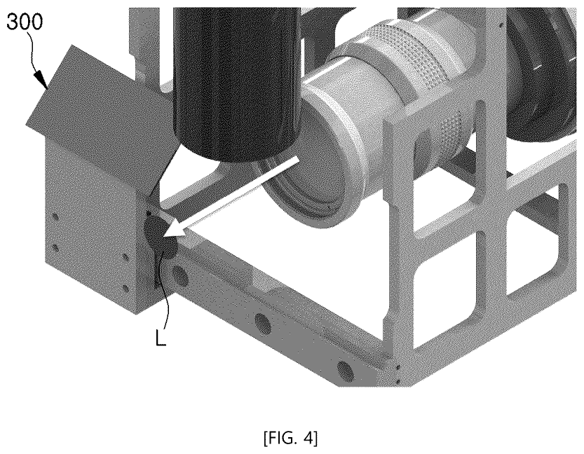

As shown in FIGS. 4 to 6, the optical switching unit (300) is configured to switch between the use of the wide 1D line scan camera (100) and the 2D area scan camera (200) while moving the optical switching unit (300) in a linear motion using a sliding device (310), and the sliding device (310) can be controlled by the control unit (400).

FIG. 4 illustrates the state where the wide 1D line scan camera (100) is capable of observing ink droplets due to the sliding motion when the optical switching unit (300) is configured as a reflective mirror. L represents the area observable by the wide 1D line scan camera (100). According to an embodiment of the present invention, used, the image circle of the 1D line scan camera is approximately 16.4 mm, when a 5× lens is used for approximately 82 mm.

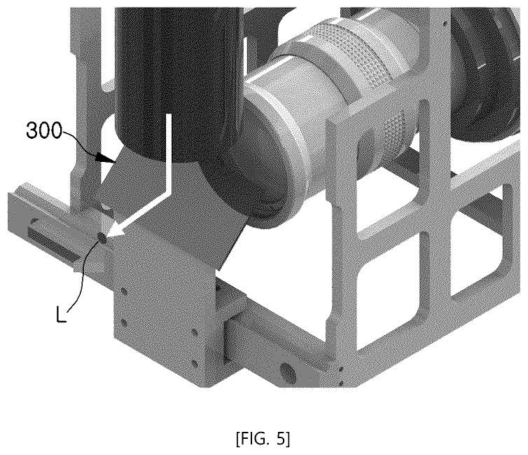

FIG. 5 illustrates the state where the 2D area scan camera (200) is capable of observing ink droplets due to the sliding motion when the optical switching unit (300) is configured as a reflective mirror. L represents the area observable by the 2D area scan camera (200), and the horizontal width of the observable FOV (field of view) area is approximately 2.1 mm.

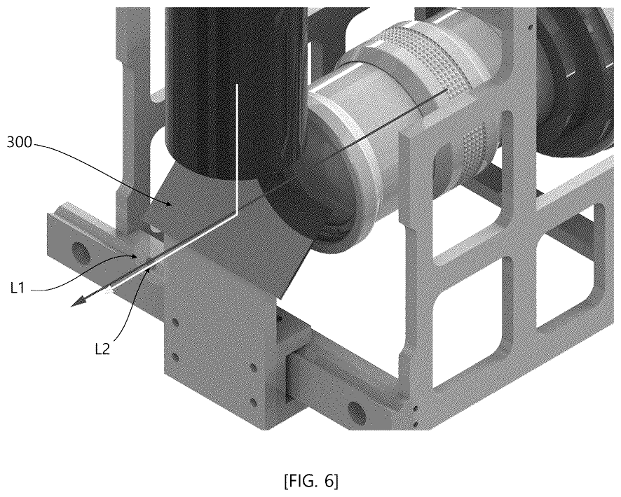

FIG. 6 illustrates the state where both the wide 1D line scan camera (100) and the 2D area scan camera (200) can observe ink droplets simultaneously when the optical switching unit (300) is configured as a translucent mirror. L1 represents the area observable by the wide 1D line scan camera (100), and L2 represents the area observable by the 2D area scan camera (200). However, because the light from the optical strobe(S) is split and directed towards both the wide 1D line scan camera (100) and the 2D area scan camera (200), the brightness of the images captured by each camera may be lower. To prevent this, the light from the optical strobe(S) must have a very high luminance.

### [Folding Method]

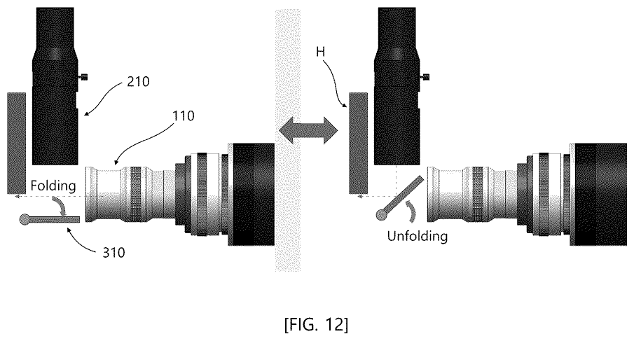

The optical switching unit (300) switches between the use of the wide 1D line scan camera (100) and the 2D area scan camera (200) by adjusting the inclination angle using a folding device (310), as shown in FIG. 12. Here, the folding device (310) can be controlled by the control unit (400).

### [Rotating Method]

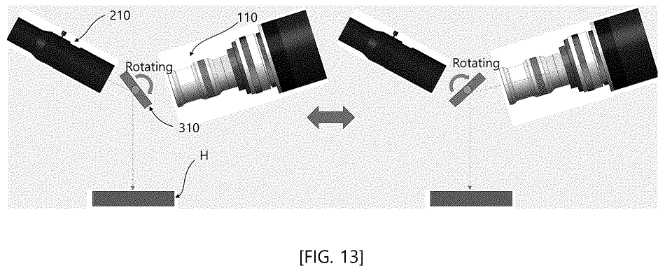

When the wide 1D line scan camera (100) and the 2D area scan camera (200) are arranged on the same axis (i.e., in parallel) or at an angle within 180 degrees, the optical switching unit (300) can be rotated by a rotating device (310) to switch between the use of the wide 1D line scan camera (100) and the 2D area scan camera (200), as shown in FIG. 13. Here, the rotating device (310) can be controlled by the control unit (400).

The optical switching unit (300) also encompasses methods for switching between the use of the 1D line scan camera and the 2D area scan camera by adjusting reflectance or using prisms, optical switches, and other means.

The control unit (400) collects the high-resolution, low-volume ink droplet image data captured by the wide 1D line scan camera (100) at the set period, perform image processing to generate and image 2D spatiotemporal information of the ink droplet, and acquires relative comparison data for the ink droplets using the imaged 2D spatiotemporal information.

In this case, when ejection frequency of the ink droplet ejected from the inkjet print head (H) is denoted as f₁, the operating frequency of the wide 1D line scan camera (100) and the optical strobe(S) is the same as f₁, but has a variable delay time with respect to the start point of the driving voltage applied to the inkjet print head (H). This enables the acquisition of high-resolution, low-volume 1D image data over sequential time.

At this time, during each image capture, the control unit (400) intervenes to ensure that the wide 1D line scan camera (100) and optical strobe(S) operate at a time point delayed by Δt relative to the previous one. In other words, the control unit (400) receives the end-of-capture signal from the wide 1D line scan camera (100) and the optical strobe(S), and, in response, sets a new delay time by adding Δt to the existing delay time for next capture. The control unit then sends to the wide 1D line scan camera (100) and optical strobe(S) signals that notify them of the new driving time point based on the variable delay time.

To avoid the complexity of controlling the wide 1D line scan camera (100) and the optical strobe(S) for ink droplet capture, the ink droplet ejection frequency 71 of the inkjet print head (H) and the operating frequency f₂ of the wide 1D line scan camera (100) and the optical strobe(S) can be set differently. When the operating frequency f₁ of the inkjet print head and the operating frequency f₂ of the wide 1D line scan camera and optical strobe are set differently, the delay time Δt for each inkjet print head driving cycle can be calculated using the following [Mathematical Formula 1], and the variable delay time is the cumulative sum of the delay Δt for each driving cycle.

$$Δ t = Δ ( 1 / f ) abs ( 1 / {f}_{1} - 1 / {f}_{2} ) \qquad [ Mathematical Formula 1 ]$$

[Where, f₁ represents the operating frequency of the inkjet print head, and f₂ represents the operating frequency of the wide 1D line scan camera and optical strobe. Therefore, 1/f₁ is the ink droplet ejection period of the inkjet print head, and 1/f₂ is the operating period of the wide 1D line scan camera and optical strobe. The difference Δ(1/f) between these two periods represents the delay time Δt of the time point at which the 1D line scan camera and optical strobe operate each time the ink droplet is ejected]

As described above, when the ejection frequency f₁ of the inkjet print head (H) and the operating frequency f₂ of the wide 1D line scan camera (100) and optical strobe(S) are set to different values, since the control unit (400) does not need to intervene to change the delay time for each capture. This provides control convenience, and since the capturing of the wide 1D line scan camera (100) occurs at intervals of the difference Δ(1/f) between the reciprocals of the two frequencies, high temporal resolution can be achieved.

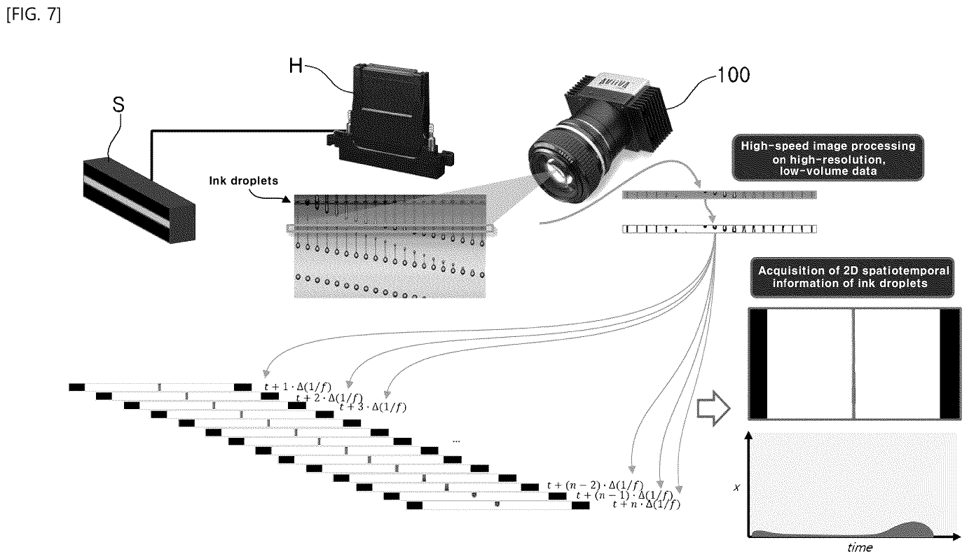

In FIG. 7, for convenience of explanation, it is assumed that ink droplets are ejected from only one nozzle of the multiple nozzles of the inkjet print head (H). Under this assumption, the control unit (400) collects and performs image processing the 1D high-resolution, low-volume ink droplet image data acquired by the wide 1D line scan camera (100) during the set period, and then obtains the ink droplet 2D spatiotemporal information.

The spatiotemporal graph shown at the lower right of FIG. 7 represents the image-processed ink droplet 2D spatiotemporal information. This information is compared with the stored reference ink droplet 2D spatiotemporal information to determine whether the ink droplet is normal.

The control unit (400) also switches from the wide 1D line scan camera (100) to the 2D area scan camera (200), collects the shape image data of the ink droplet captured at a specific time, performs image processing on the collected image data, generates 2D spatial information of the ink droplet at that specific time, and then images it. The imaged 2D spatial information of the ink droplet is used to acquire the basic physical characteristic data of the ink droplet, such as the falling speed, length, width, and volume of the ink droplet.

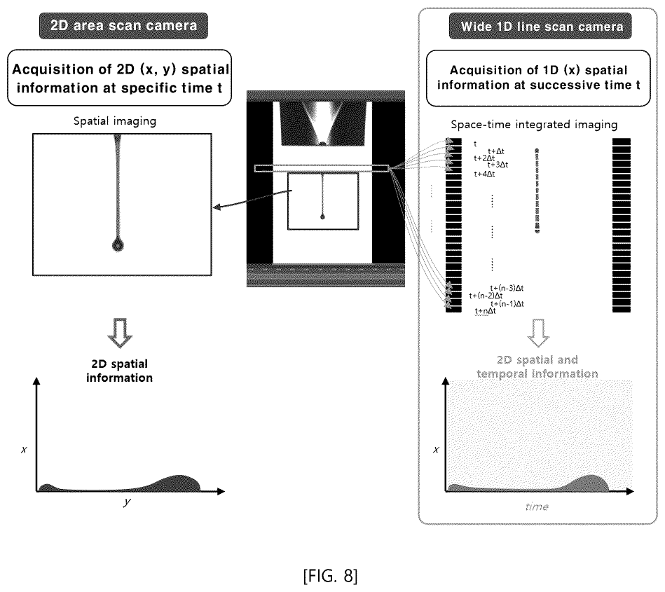

FIG. 8 shows the difference between the 2D spatiotemporal information generated from the high-resolution, low-volume ink droplet image data acquired by the wide 1D line scan camera (100) at continuous time t, and the 2D spatial information of the ink droplet at a specific time t generated from the shape image data acquired by the 2D area scan camera (200).

The control unit (400) can control the operation of the device that drives the optical switching unit (300) (i.e., the sliding device, folding device, or rotating device).

The display unit (500) receives and displays the relative comparison data and basic physical characteristic data of the ink droplets, which are acquired by the control unit (400). In addition to the relative comparison data and basic physical characteristic data of the ink droplets, the displayed items may include 1D high-resolution low-volume ink droplet images acquired by the wide 1D line scan camera (100), the ink droplet 2D spatiotemporal information generated through image processing, and the shape images of the ink droplets captured by the 2D area scan camera (200) at a specific time, along with the 2D spatial information of the ink droplets at that specific time generated by image processing.

The high-speed monitoring method of ink droplets using the inkjet ink droplet high-speed monitoring system with the 1D and 2D image acquisition devices according to the embodiment of the invention configured as described above will now be explained.

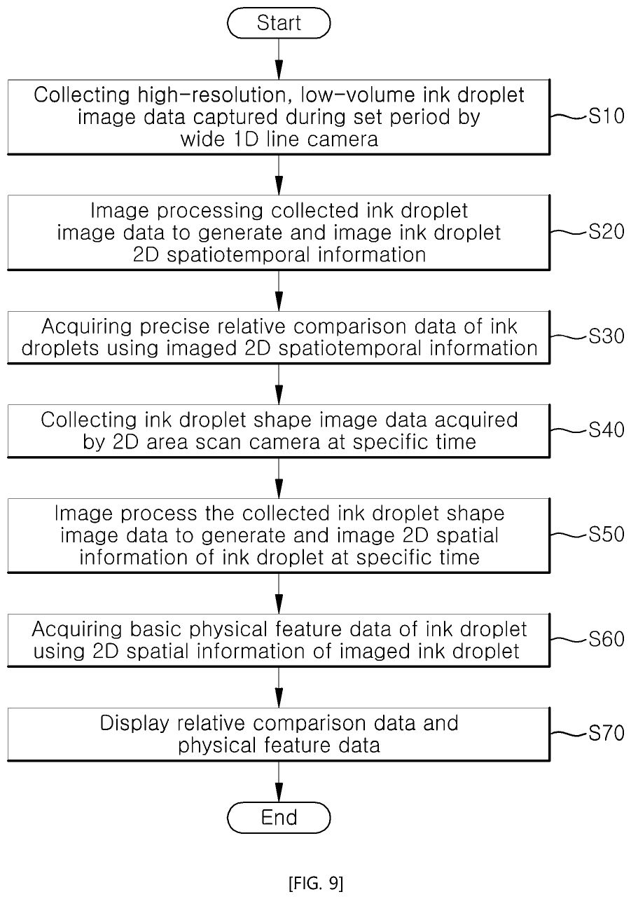

FIG. 9 is a flowchart for explaining the high-speed monitoring method of inkjet ink droplets using the high-speed monitoring system of inkjet ink droplets according to the embodiment of the present invention, where “S” denotes a step.

Before explaining the high-speed monitoring method of inkjet ink droplets, it is assumed that light is irradiated onto the ink droplets falling from the inkjet print head (H) by one or more light strobes(S), the wide 1D line scan camera (100) captures the ink droplets during the set period to acquire the high-resolution low-volume ink droplet image data, and the shape image data of the ink droplet is acquired by the 2D area scan camera (200) at a specific time.

First, the control unit (400) collects the high-resolution, low-volume ink droplet image data acquired by capturing the ink droplets falling from the inkjet print head (H) over the set period using the wide 1D line scan camera (100) (S10).

Next, the control unit (400) performs image processing on the collected high-resolution, low-volume ink droplet image data to generate and image ink droplet 2D spatiotemporal information (S20).

Then, the control unit (400) uses the imaged ink droplet 2D spatiotemporal information to acquire relative comparison data of the ink droplets (S30).

Next, the control unit (400) collects shape image data of the ink droplet acquired by capturing the ink droplets falling from the inkjet print head (H) at a specific time by the 2D area scan camera (200) (S40).

Next, the control unit (400) performs image processing on the collected shape image data of the ink droplet to generate and images the 2D spatial information of the ink droplet at the specific time (S50).

Then, the control unit (400) uses the imaged 2D spatial information of the ink droplet to acquire the basic physical characteristic data of the ink droplets (S60).

Next, the control unit (400) displays the relative comparison data of the ink droplets acquired in step (S30) and the basic physical characteristic data acquired in step (S60) on the display unit (500) (S70).

According to the high-speed monitoring system for inkjet ink droplets with 1D and 2D image acquisition devices according to the embodiment of the present invention and the high-speed monitoring method using the same, the use of two cameras is optically switched by the optical switching unit disposed between the wide 1D line scan camera and the 2D area scan camera, the high-resolution, low-capacity ink droplet image data captured at the set period by the wide 1D line scan camera is collected and image-processed to generate and image 2D spatiotemporal information of the ink droplets, the relative comparison data of the ink droplets is acquired using the imaged 2D spatiotemporal information, the shape image data of the ink droplets captured at the specific time by the 2D area scan camera is collected and image-processed to generate and image 2D spatiotemporal information of the ink droplets at the specific time, and the basic physical characteristic data of the ink droplets is acquired using the 2D spatiotemporal information of the imaged ink droplets, thereby capable of monitoring ink droplets falling from multiple nozzles at high speed, and acquiring the shape of ink droplets falling from a small number of nozzles and measuring their basic physical properties.

The optimum exemplary embodiments have been disclosed and the specific terms are used in the drawings and the specification, but the exemplary embodiments and the terms are used just for the purpose of describing the exemplary embodiments of the present disclosure, but not used to limit meanings or restrict the scope of the present disclosure disclosed in the claims. Therefore, those skilled in the art will understand that various modifications of the exemplary embodiment and any other exemplary embodiments equivalent thereto are available. Accordingly, the true technical protection scope of the present disclosure should be determined by the technical idea of the appended claims.

1. A high-speed monitoring system for inkjet ink droplets with 1D and 2D image acquisition devices, comprising:
a light strobe(S) using one or more LEDs or LEPs (laser-excited phosphors), configured to irradiate light for ink droplets falling from an inkjet print head (H);
a wide 1D line scan camera (100) positioned opposite the light strobe, configured to capture ink droplets at a set period and acquire high-resolution, low-capacity ink droplet image data;
a 2D area scan camera (200) arranged at a certain angle relative to the wide 1D line scan camera, configured to acquire ink droplet shape image data at a specific time;
an optical switching unit (300) positioned between the wide 1D line scan camera and the 2D area scan camera, configured to optically switch between use of the two cameras; and
a control unit (400) configured to:
collect high-resolution, low-capacity ink droplet image data captured by the wide 1D line scan camera at the set period, perform image processing to generate and image 2D spatiotemporal information of the ink droplets, acquire relative comparison data of the ink droplets using the imaged 2D spatiotemporal information, collect ink droplet shape image data captured at the specific time by the 2D area scan camera, perform image processing the ink droplet shape image data to generate 2D spatial information of the ink droplets at the specific time, image the 2D spatial information, and acquire basic physical characteristic data of the ink droplets using the imaged 2D spatial information.

2. The high-speed monitoring system for inkjet ink droplets with 1D and 2D image acquisition devices according to claim 1, further comprising:
a display unit (500) configured to receive and display the relative comparison data and basic physical characteristic data of the ink droplets acquired by the control unit (400).

3. The high-speed monitoring system for inkjet ink droplets with 1D and 2D image acquisition devices according to claim 1, wherein:
the basic physical characteristic data of the ink droplets includes a falling velocity, length, width, and volume of the ink droplets.

4. The high-speed monitoring system for inkjet ink droplets with 1D and 2D image acquisition devices according to claim 1, wherein:
the optical switching unit (300) is a reflective mirror or a semi-transparent mirror.

5. The high-speed monitoring system for inkjet ink droplets with 1D and 2D image acquisition devices according to claim 1, wherein:
the optical switching unit (300) is configured to switch between use of the wide 1D line scan camera (100) and the 2D area scan camera (200) while moving linearly by a sliding device (310),
and at this time, the sliding device is controlled by the control unit (400).

6. The high-speed monitoring system for inkjet ink droplets with 1D and 2D image acquisition devices according to claim 1, wherein:
the optical switching unit (300) is configured to switch between use of the wide 1D line scan camera (100) and the 2D area scan camera (200) while adjusting its inclination angle by a folding device (310),
and at this time, the folding device is controlled by the control unit (400).

7. The high-speed monitoring system for inkjet ink droplets with 1D and 2D image acquisition devices according to claim 1, wherein:
the wide 1D line scan camera (100) and the 2D area scan camera (200) are arranged either on a same axis or at a predetermined opposing angle,
the optical switching unit (300) is configured to switch between use of the wide 1D line scan camera and the 2D area scan camera while rotating by a rotation device (310),
and at this time, the rotation device is controlled by the control unit (400).

8. The high-speed monitoring system for inkjet ink droplets with 1D and 2D image acquisition devices according to claim 4, wherein:
when the optical switching unit (300) is a semi-transparent mirror, the wide 1D line scan camera (100) and the 2D area scan camera (200) can perform simultaneous observation,
and at this time, the light strobe(S) is configured to generate high-brightness light to compensate for decrease in an amount of light incident on the 1D line scan camera and the 2D area scan camera by the semi-transparent mirror.

9. A high-speed monitoring method for inkjet ink droplets using a high-speed monitoring system for inkjet ink droplets with 1D and 2D image acquisition devices, comprising:
a step in which a control unit (400) collects high-resolution, low-capacity ink droplet image data acquired by capturing ink droplets falling from an inkjet print head at a set period by a wide 1D line scan camera (100);
a step in which the control unit performs image processing on the collected high-resolution, low-capacity ink droplet image data to generate and image 2D spatiotemporal information of the ink droplets;
a step in which the control unit acquires relative comparison data of the ink droplets using the imaged 2D spatiotemporal information of the ink droplets;
a step in which the control unit collects shape image data of ink droplets acquired by capturing the ink droplets falling from the inkjet print head at a specific time by a 2D area scan camera (200);
a step in which the control unit performs image processing the collected shape image data of the ink droplets to generate and image 2D spatiotemporal information of the ink droplets at the specific time;
a step in which the control unit acquires basic physical characteristic data of the ink droplets using 2D spatial information of the imaged ink droplets; and
a step in which a display unit receives and displays the relative comparison data and basic physical characteristic data of the ink droplets obtained by the control unit.

10. The high-speed monitoring method for inkjet ink droplets according to claim 9, wherein:
the basic physical characteristic data of the ink droplets includes a falling velocity, length, width, and volume of the ink droplets.
